(19) United States
(12) Patent Application Publication
(10) Pub. No.: US 2007/0230789 A1
(43) Pub. Date: Oct. 4, 2007

(54) Method of controlling an electronic device by handwriting

(75) Inventors: Tzu-Chiang Chang, Taipei (TW); Kuo-Cheng Hung, Taipei (TW)

Correspondence Address: BRUCE H. TROXELL, SUITE 1404, 5205 LEESBURG PIKE, FALLS CHURCH, VA, 22041, US

(73) Assignee: Inventec Appliances Corp.

(21) Appl. No.: 11/395,229

(22) Filed: Apr. 3, 2006

(51) Int. Cl. G06K 9/00

(52) U.S. Cl. 382/187

(57) ABSTRACT

A method for controlling an electronic device by handwriting includes the steps: (a) receiving a handwritten pattern for recognition; (b) analyzing the handwritten pattern to divide the handwritten pattern into a primary feature and a secondary feature; (c) searching the storage device for a second predetermined pattern having the primary feature; and (d) comparing the second predetermined pattern with respect to the secondary feature in order to select a third predetermined pattern, in which, the secondary feature matches the handwritten pattern; (e) executing an operation function of the electronic device represented by the third predetermined pattern.

### FIELD OF THE INVENTION

The present invention relates to a method for controlling an electronic device by handwriting, more particularly to a handwriting method for replacing the conventional method of inputting instructions by pressing the input keys.

### BACKGROUND OF THE INVENTION

Advance of technology enables an electronic device to possess multi-functions. For example, the fax, the printer and scanner are incorporated into a multi-function apparatus. A photographing apparatus is incorporated into the mobile phone so that the user can take pictures with the mobile phone if circumstances demand. Though the late electronic device possesses multi-functions, the instruction for accomplishing an operation is generally controlled by the input keys, thereby causing inconveniences to the user. An example of the electronic device is given in detail in the following paragraphs.

FIG. 1 illustrates a conventional mobile phone 10 that includes a plurality of input keys for inputting instructions of the operational function. The mobile phone 10 generally includes several numerical keys 11, a function-selection key 12, a confirmation key 13 and a cancel key 14. In order to achieve the different operations in the mobile phone 10, each key (being a button) may be printed with a symbol in addition to its original function. For instance, the numeral key 11 for inputting 1 originally is printed with additional characters “A” and [symbol] (Chinese character) in addition to 1. The mobile phone 10 further includes a stepwise selection list 15 (i.e. a screen) with a plurality of blocks 121 representing a variety of function figures 151. A desired block 121 representing a respective function can be selected by pressing upper, lower, left and right parts of the function-selection key 12. Confirmation is done by pressing the key 13 once the desired function is selected.

Selecting the desired function by using stepwise selection list 15 is inconvenient to the user, since a relatively long time is required to choose the desired function. Moreover, the user needs to press the same key several times in order to choose the desired function. For example, during compiling a short message in Chinese to be mailed out, if the message is written by incorporating a few English letters and some symbols, some specific keys must be pressed again and again in order to choose the desired function. Inputting the instructions into the electronic device is generally controlled by pressing the input keys. Since the functions of the electronic device are more than the keys and due to the limited size of the electronic device, the stepwise selection list 15 is designed.

The drawback of time-wasting by using the stepwise selection list 15 can be remedied once the electronic device is provided with an input interface. Because the input instruction can be written onto the interface by handwriting, whereby the problem of setting the plurality of blocks 121 representing function figures 151 can be eliminated. Until now, the art of identifying technology is only used for recognizing the handwritten words or symbols.

### SUMMARY OF THE INVENTION

Therefore, the object of the present invention is to find a method for controlling an electronic device by handwriting for replacing the conventional method of inputting instructions by pressing the input keys.

Another object of the present invention is to find a method for controlling an electronic device by handwriting, the electronic device has high recognizing ability.

Still another object of the present invention is to find a method for controlling an electronic device by handwriting, thereby eliminating the problem of time-wasting in searching the desired function from the function selection list.

In another aspect of the present invention, a method is provided for controlling an electronic device by handwriting. The electronic device includes a storage device that stores at least a first predetermined pattern in advance, the first predetermined pattern representing an operation function of the electronic device. The method includes the steps: (a) receiving a handwritten pattern for recognition; (b) analyzing the handwritten pattern into a primary feature and a secondary feature; (c) searching the storage device for at least a second predetermined pattern having the primary feature; and (d) comparing the second predetermined pattern with respect to the secondary feature in order to select a third predetermined pattern of which the secondary feature matches the handwritten pattern; (e) executing an operation function of the electronic device represented by the third predetermined pattern.

In another aspect of the present invention, an electronic device which is controlled by inputted handwritten pattern is provided. The electronic device includes: a function module including a plurality of function modes, each of the function modes representing an operation function of the electronic device; and a control module including a handwriting input interface for receiving a handwritten pattern thereon for recognition, an analyzing unit connected to the handwriting input interface to divide the handwritten pattern into a primary feature and a secondary feature, a storage device for storing at least a first predetermined pattern therein in advance, the first predetermined pattern representing an operation function in the function module, a searching unit connected to the analyzing unit for searching the storage device for at least a second predetermined pattern having the primary feature, and a comparing unit connecting to the analyzing unit and the searching unit for comparing the second predetermined pattern with respect to the secondary feature in order to select a third predetermined pattern of which the secondary feature matches the handwritten pattern.

### BRIEF DESCRIPTION OF THE DRAWINGS

Other features and advantages of this invention will become more apparent in the following detailed description of the preferred embodiments of this invention, with reference to the accompanying drawings, in which:

FIG. 1 illustrates a conventional mobile phone;

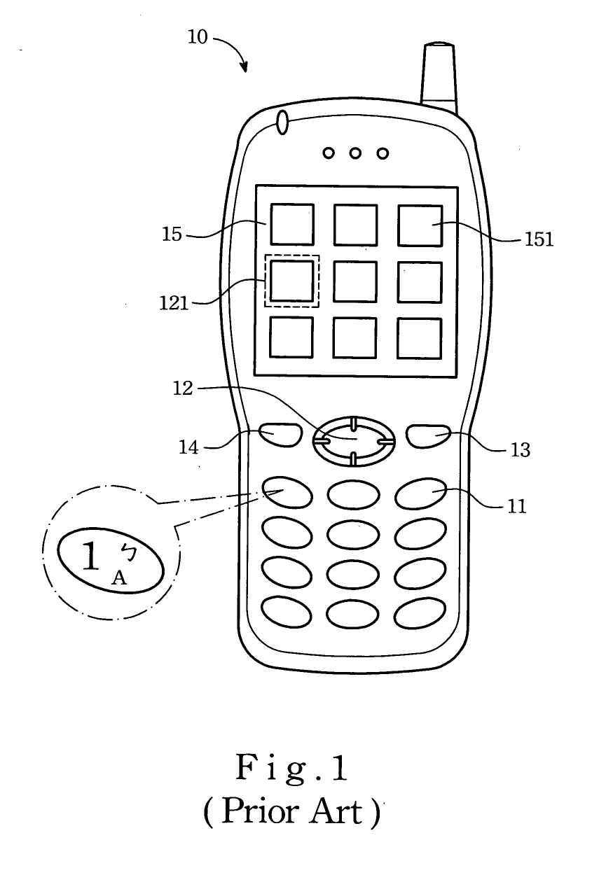

FIG. 2 is a flowchart illustrating the steps for controlling an electronic device by handwriting according to the present invention;

FIG. 3 is a flowchart illustrating the method for controlling an electronic device by handwriting according to the present invention in another form;

FIG. 4 is a block diagram representing the components of the electronic device according to the present invention; and

FIG. 5 is a schematic view of the mobile phone according to the present invention.

### DETAILED DESCRIPTIONS OF THE PREFERRED EMBODIMENTS

An electronic device (such as a mobile phone) includes a plurality of input keys, each key generally representing a single function of the electronic device. A method is provided according to the present invention for controlling an electronic device by handwriting so as to overcome the problem of insufficiency of input keys in the electronic device since the latter has more and more function due to rapid advance of the electronic technology and due to ever-reducing dimension of the electronic device. When handwritten pattern is scribbled onto the electronic device, a quick search and precise recognition of the handwritten pattern relative to a predetermined pattern stored within a storage device of the electronic device can be achieved. An example of the controlling method is given in the following paragraphs.

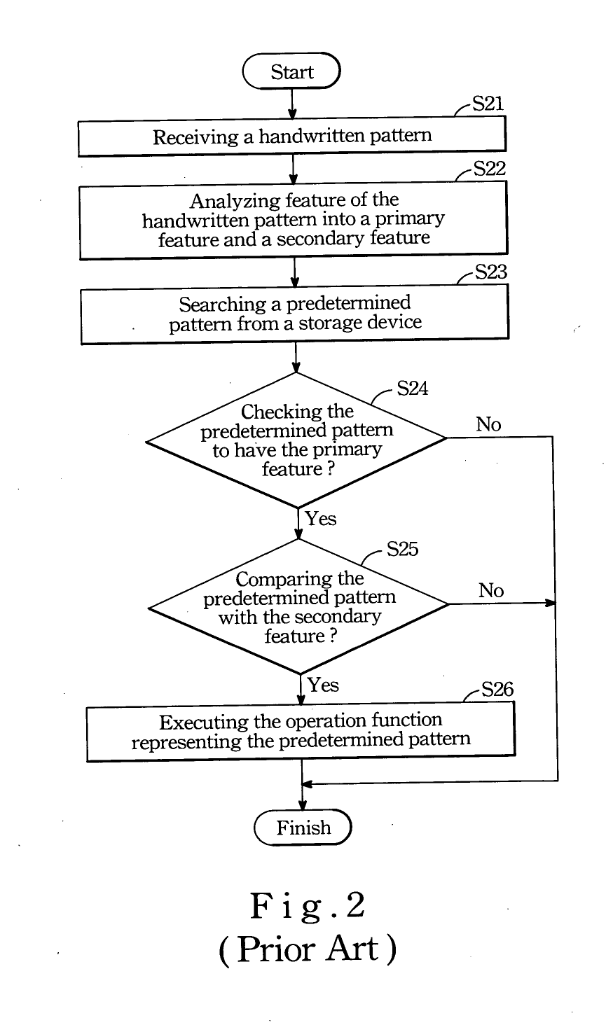

FIG. 2 is a flow chart illustrating the steps for controlling an electronic device (such as a mobile phone) by handwriting. According to the step (S21), a handwritten pattern is received in the electronic device for recognition. Of course, the electronic device has a storage device that stores at least a first predetermined pattern, and the first predetermined pattern representing a single operation function thereof. The handwritten pattern is scribbled onto a touch panel of the electronic device by the user (preferably by a styli or a touch pen). The handwritten pattern is analyzed according to the step (S22) in such a manner that the handwritten pattern is divided into a primary feature and a secondary feature. Step (S23), a searching operation is conducted within the storage device to locate a predetermined pattern. Step (S24), check whether the primary feature has feature similar to the predetermined pattern since the latter represents a single function of the electronic device. According to the step (S25), the second predetermined pattern is compared with respect to the secondary feature in order to select a third predetermined pattern, of which the secondary feature matches the handwritten pattern. Step (S26), an operation function of the electronic device represented by the third predetermined pattern is executed.

The aforementioned primary feature may be selected from a group consisting of size, configuration, angle, line thinness or thickness, basic handwriting structure, inclination, and blank space. Preferably, one of the size, the configuration, the viewing angle, the thinness and thickness of the forming patterns, the basic word structure, the inclination and the blank space serves as a reference for defining (recognizing) the primary feature.

The aforementioned secondary feature may be selected from a group consisting of size, configuration, angle, line thinness or thickness, basic handwriting structure, inclination, and blank space. Preferably, a combination of at least two of the size, the configuration, the viewing angle, the thinness and thickness of the forming patterns, the basic word structure, the inclination and the blank space serves as a reference for defining (recognizing) the secondary feature. There may exist several second predetermined patterns within the storage device matching the primary feature. However, one or more second predetermined patterns can be compared with respect to the secondary feature in order to select a third predetermined pattern of which the secondary feature matches the handwritten pattern.

The controlling method can further include a step of recording a stroke arrangement, a trace or direction, or forces applied to parts of the handwritten pattern during writing of the handwritten pattern upon the step (S21) and prior to the step (S22). For instance, the thickness and thinness (or the trace of directions) of the strokes of the handwritten pattern can be analyzed in detail for serving as the reference when recognizing the primary feature.

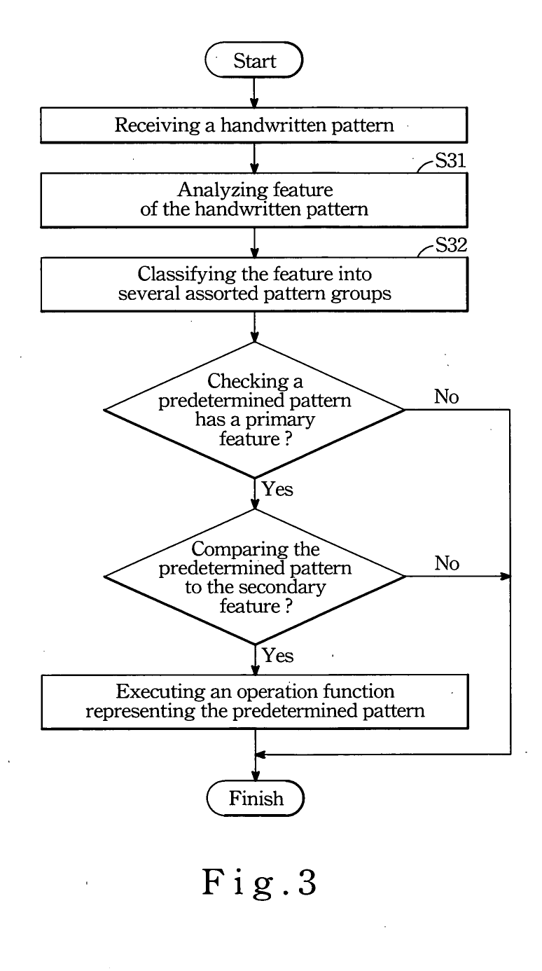

FIG. 3 shows a flowchart of one embodiment of the controlling method for an electronic device by handwriting. According to the step (S31), the handwritten pattern is analyzed into a primary feature and a secondary feature. The primary and secondary features are classified into several assorted feature groups according to the step (S32) such that each group possesses the specific feature different from the other group. The second predetermined pattern with primary feature can be grouped together according to the stress of strokes or Letters, for instance [À, Á, Â, Ã, Ä, \dot{A}]. Note that in this group, the Letter “A”, “A” is the general feature of the group. Another example of the group is [symbol] [symbol] , wherein each of the patterns is based on the symbol □ (square configuration), “□” being the general feature of the group. During searching the storage device for a second predetermined pattern having the primary feature for comparing with the handwritten pattern, the user needs to set □ or A at the initial stage in order to shorten the searching time.

On the other hand, after the searching operation, several comparing steps for comparing the handwritten pattern with the second predetermined pattern are consequently reduced once □ or A is found. The reduction of the comparing steps is achieved since not the whole part of the handwritten pattern is compared with the second predetermined pattern. For instance, assuming that the handwritten pattern is [symbol] , then less time will be needed for searching the middle portion (blank space) of [symbol] , since the outer periphery is similar to □ in configuration. It is apparent that the searching and comparing time required by the method is shortened without affecting the precision of recognizing the handwritten pattern.

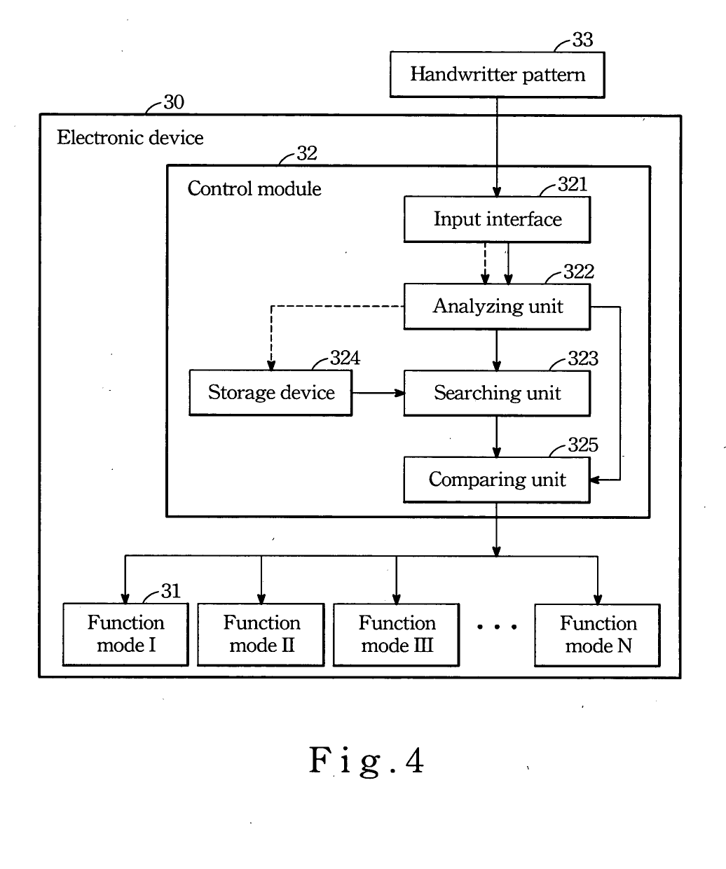

FIG. 4 illustrates a block diagram representing the components of the electronic device 30 according to the present invention. The electronic device 30 includes a function module 31 and a control module 32. The function module 31 includes a plurality of function modes, each of the function modes representing an operation function of the electronic device. The control module 32 includes a handwriting input interface 321 (such as a touch panel) for receiving a handwritten pattern 33 for recognition, an analyzing unit 322, a storage device 324, a searching unit 323, and a comparing unit 325. The analyzing unit 322 is connected to the handwriting input interface 321 to divide the handwritten pattern into a primary feature and a secondary feature. The storage device 324 is stored with a first predetermined pattern therein. The first predetermined pattern represents an operation function in the function module. The searching unit 323 is connected to the analyzing unit 322 for searching the storage device for a second predetermined pattern having the primary feature. The comparing unit 325 is connected to the analyzing unit 322 and the searching unit 323 for comparing the second predetermined pattern with respect to the secondary feature in order to select a third predetermined pattern, of which the secondary feature matches the handwritten pattern. Finally, the operation function represented by the third predetermined pattern is executed.

Note that in the aforementioned control module 32, a new predetermined pattern can be added to the storage device 324 at any time. In the same manner, the first predetermined pattern within the storage device 324 can be modified at any time if circumstance desires. Moreover, the first predetermined pattern can be deleted from the storage device 324 at any time. In case the user adds a [+] into the storage device 324, a new pattern representing the [+] must also be inputted such that the analyzing unit 322 will divide the feature of the new pattern into the primary and the secondary feature. Of course, some software must be employed for conducting the comparing operation.

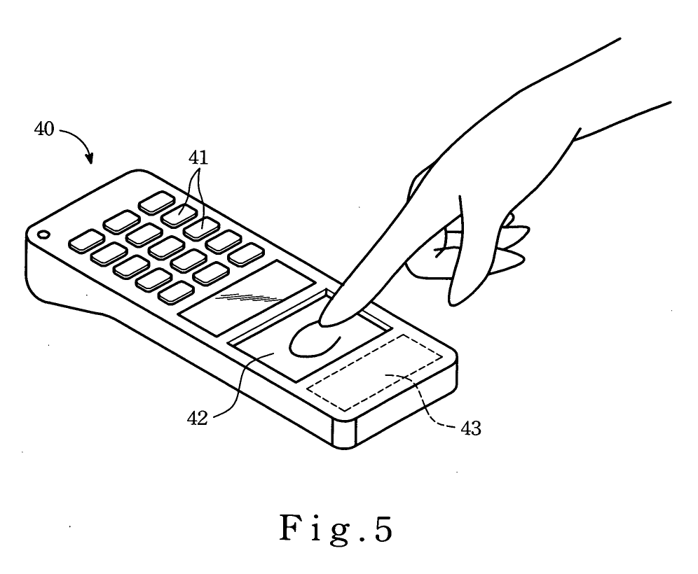

FIG. 5 illustrates how the controlling method by handwriting of the present invention is employed in a mobile phone 40. The mobile phone 40 has an input interface 42 in addition to the press keys 41. At least a predetermined pattern (such as characters or symbols) can be stored within the storage device 43 in advance. Note that in the prior art electronic device, the user needs to select the desired function from the function selection list by pressing the keys several times. In contrast, in case the user using the present controlling method can set the alarm signal in the mobile phone shown in FIG. 5 only by scribbling the symbol [symbol] on the input interface 42, and the mobile phone 40 will immediately signal the alarm signal since the symbol [symbol] is preset within the storage device 43 for representing the alarm signal. In case, the user wishes to find out the phone number of a friend whose name is “sunny”, he can locate the name by scribbling the symbol [symbol] on the touch panel and then the mobile phone 40 is able to be in communication with the mobile phone owned by Mr. “sunny”. Since inputting the handwritten pattern on the touch panel of the mobile phone does not generate noise, such controlling method for mobile phones is most preferred to in the environment where complete silence is required, such as in a library. A styli or touch pen can be used for inputting the handwritten pattern. Any other means (like user's fingers) can also be used for inputting the handwritten pattern. Therefore the scope of the present invention should not be limited only to the disclosed embodiments.

In summary, the method of the present invention for controlling an electronic device by handwriting provides the following advantages:
(i) The handwriting method is faster than the conventional method of inputting instructions by pressing the input keys;
(ii) A single key serving multi-purposes is eliminated, and the searching and comparing time will be shortened; and
(iii) Reduction in the searching and comparing operations can prolong the service life of the electronic device.

While the invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

We claim:

1. A method for controlling an electronic device by handwriting, the electronic device including a storage device storing at least a first predetermined pattern in advance, the first predetermined pattern representing an operation function of the electronic device, the method comprising the steps:
(a) receiving a handwritten pattern for recognition;
(b) analyzing said handwritten pattern into a primary feature and a secondary feature;
(c) searching the storage device for at least a second predetermined pattern having said primary feature;
(d) comparing said a second predetermined pattern with respect to said secondary feature in order to select a third predetermined pattern of which said secondary feature matches said handwritten pattern; and
(e) executing an operation function of the electronic device represented by said third predetermined pattern.

2. The controlling method according to claim 1, further comprising a step (f) for recording upon the step (a) and prior to the step (b), a stroke arrangement, a trace or direction, or forces applied to parts of said handwritten pattern during writing of said handwritten pattern.

3. The controlling method according to claim 1, wherein said primary feature is selected from a group consisting of size, configuration, angle, line thinness or thickness, basic handwriting structure, inclination, and blank space.

4. The controlling method according to claim 1, wherein said secondary feature is selected from a group consisting of size, configuration, angle, line thinness or thickness, basic handwriting structure, inclination, and blank space.

5. The controlling method according to claim 1, further comprising a step (g) of generating a feature category for initial classification of said primary feature after the step (b).

6. The controlling method according to claim 1, further comprising a step (h) of adding a new predetermined pattern to the storage device at any time.

7. The controlling method according to claim 1, further comprising a step (i) of modifying said first predetermined pattern in the storage device at any time.

8. The controlling method according to claim 1, further comprising a step (j) of deleting said first predetermined pattern from the storage device at any time.

9. An electronic device adapted to be controlled by handwriting, including a function module and a control module, wherein the control module comprises:
a handwriting input interface for receiving a handwritten pattern for recognition;
an analyzing unit connected to said handwriting input interface to divide said handwritten pattern into a primary feature and a secondary feature;
a storage device for storing at least a first predetermined pattern therein, said first predetermined pattern representing an operation function in said function module;
a searching unit connecting to said analyzing unit for searching the storage device for at least a second predetermined pattern having said primary feature; and
a comparing unit connected to said analyzing unit and said searching unit for comparing said second predetermined pattern with respect to said secondary feature in order to select a third predetermined pattern, in which said secondary feature matches said handwritten pattern.

10. The electronic device according to claim 9, wherein said handwriting input interface is a touch panel.

11. The electronic device according to claim 9, wherein the electronic device is a mobile phone.
